(19) United States
(12) Patent Application Publication
(10) Pub. No.: US 2017/0107727 A1
(43) Pub. Date: Apr. 20, 2017

(54) POURED IN PLACE CONCRETE FORM

(71) Applicant: Michael Sipala, Dix Hills, NY (US)

(72) Inventor: Michael Sipala, Dix Hills, NY (US)

(21) Appl. No.: 15/097,769

(22) Filed: Apr. 13, 2016

Related U.S. Application Data
(60) Provisional application No. 62/243,942, filed on Oct. 20, 2015.

(51) Int. Cl. E04G 11/08; E04G 9/08; E04H 13/00; B28B 23/02; E04C 5/06; B28B 11/24; B28B 1/14; E04G 13/00; E04C 1/00

(52) U.S. Cl. CPC E04G 11/08; E04G 13/00; E04G 9/08; E04H 13/003; E04C 1/00; E04C 5/0627; B28B 11/245; B28B 1/14; B28B 23/024

(57) ABSTRACT

An apparatus for forming a support box is provided. The apparatus includes a base and an insert that is attachable to the base. With the insert attached to the base, at least one suitable material is receivable within the base and allowed to harden, thereby forming a support box with at least one space for receiving a headstone.

### PRIORITY

The present application claims priority under 35 U.S.C. §119(e) to U.S. Provisional Patent Application Ser. No. 62/243,942, which was filed in the U.S. Patent and Trademark Office on Oct. 20, 2015, the entire contents of which is incorporated herein by reference.

### BACKGROUND

### 1. Field of the Disclosure

The present disclosure relates generally to a concrete form, and more particularly, to an in-place concrete form used to create a poured-in-place headstone support box.

### 2. Description of the Related Art

Conventional concrete forms are suitable for creating headstone support boxes. However, such concrete forms are rather expensive and are not easy to use. Moreover, conventional concrete forms are, typically, rendered unusable after the headstone support box is formed, due to the manner in which the concrete forms are removed from the formed headstone support boxes.

### SUMMARY

As can be appreciated, an in-place concrete form used to create a poured-in-place headstone support box may prove useful in the relevant arts.

Embodiments of the present disclosure are described in detail with reference to the drawing figures wherein like reference numerals identify similar or identical elements. As used herein, the term “distal” refers to the portion that is being described which is further from a user, while the term “proximal” refers to the portion that is being described which is closer to a user.

In accordance with an aspect of the present disclosure, there is provided an apparatus for forming a support box. The apparatus includes a base and an insert that is attachable to the base. With the insert attached to the base, at least one suitable material is receivable within the base and allowed to harden, thereby forming a support box with at least one space for receiving a headstone.

In accordance with an aspect of the present disclosure, there is provided a method for forming a support box. The method includes positioning a base around rebar framework, positioning an insert within the base, pouring at least one suitable material within the base, and allowing the at least one suitable material to harden, thereby forming a support box with at least one space for receiving a headstone.

In accordance with an aspect of the present disclosure, there is provided a system for forming a support box. The system includes rebar framework configured to be set into a footing, a base including a pair of L-shape brackets configured to releasably couple to one another, and an insert attachable to the base when the pair of L-shape brackets are coupled to one another. With the insert attached to the base, at least one suitable material is receivable within the base and allowed to harden, thereby forming a support box with at least one space for receiving a headstone.

### BRIEF DESCRIPTION OF THE DRAWING

Various embodiments of the present disclosure are described hereinbelow with references to the drawings, wherein:

FIG. 1 is a top view of a fully-assembled poured-in-place concrete form, in accordance with an embodiment of the present disclosure;

FIG. 2 is a perspective view of a base including a pair of L-shape brackets which create interlocking sides of the poured-in-place concrete form;

FIG. 3 is a perspective view of an insert, shown with its cover removed, of the poured-in-place concrete form;

FIG. 4 is a partial, perspective view of a pin mount assembly including a pin, which is configured to engage a corresponding guide-hole on a rail of one of the L-shaped brackets, of the insert;

FIG. 5 is partial, perspective view of the pin mount assembly with the pin shown engaged with the corresponding guide hole of the L-shaped bracket;

FIG. 6 is a perspective view of the pin mount assembly with the pins shown partially engaged with the corresponding guide holes of the L-shaped bracket and with the L-shaped bracket shown in a locked configuration;

FIG. 7 is a perspective view of the L-shape brackets shown in a locked configuration and with both pins of each of the pin mount assemblies of the insert shown engaged with their corresponding guide holes of the L-shaped brackets;

FIG. 8 is a perspective view of the fully-assembled poured-in-place concrete form, shown filled with concrete;

FIG. 9 is a perspective view of a formed poured-in-place headstone support box, as set on a footing, which includes a plurality of rebar framework;

FIG. 10 a top perspective view of the rebar framework, which is used to affix the poured-in-place headstone support box to the footing; and

FIG. 11 a bottom perspective view of the rebar framework.

### DETAILED DESCRIPTION

Detailed embodiments of the present disclosure are disclosed herein; however, the disclosed embodiments are merely examples of the disclosure, which may be embodied in various forms. Therefore, specific structural and functional details disclosed herein are not to be interpreted as limiting, but merely as a basis for the claims and as a representative basis for teaching one skilled in the art to variously employ the present disclosure in virtually any appropriately detailed structure.

As noted above, an in-place concrete form used to create a poured-in-place headstone support box may prove useful in the relevant arts, and such an in-place concrete form is herein described.

The FIGs. represent a design of a poured-in-place concrete form that can be used in the initial placement of cemetery headstones, as well as in the raising, resetting and realigning of existing headstones. The poured-in-place concrete form consists of a base and an insert that when coupled to one another can used with rebar framework to form a customized (i.e., having various sizes) headstone support box.

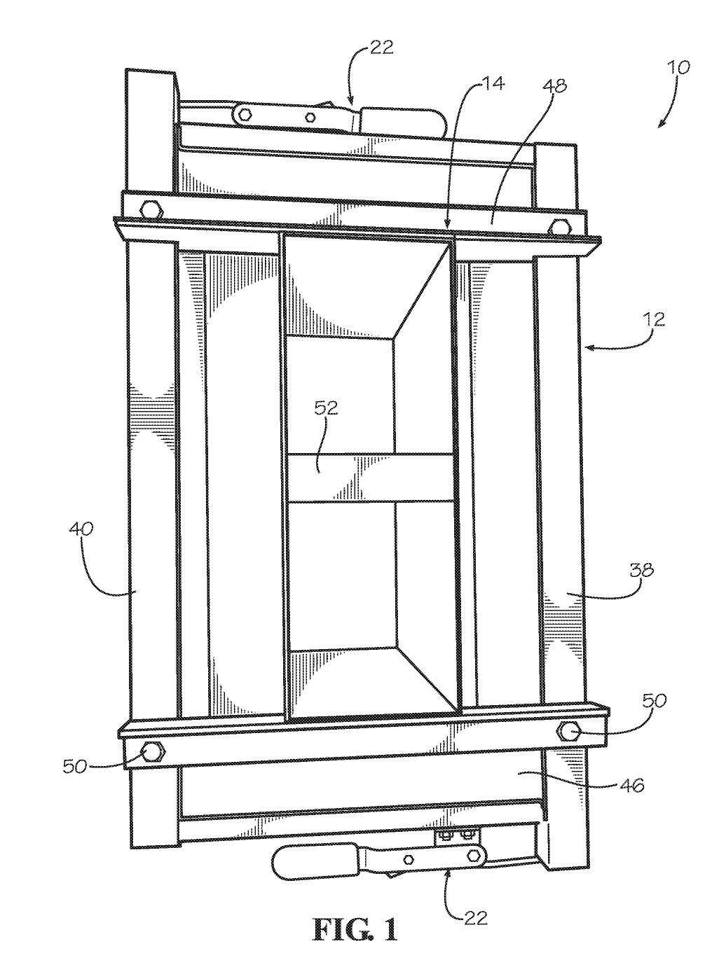

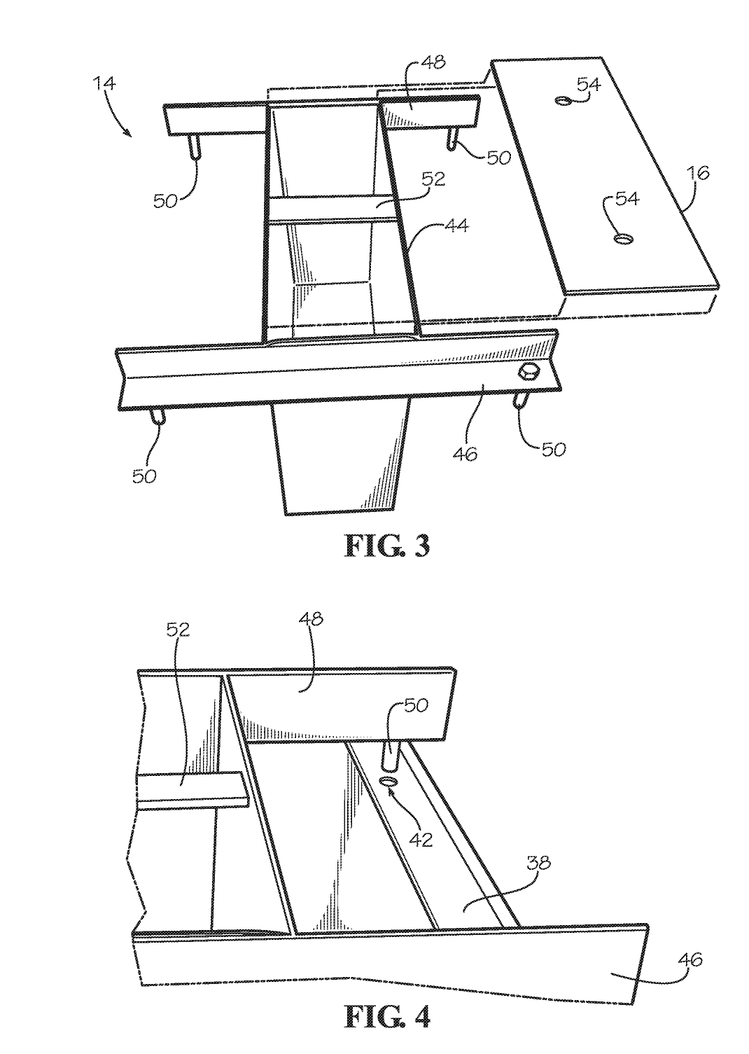

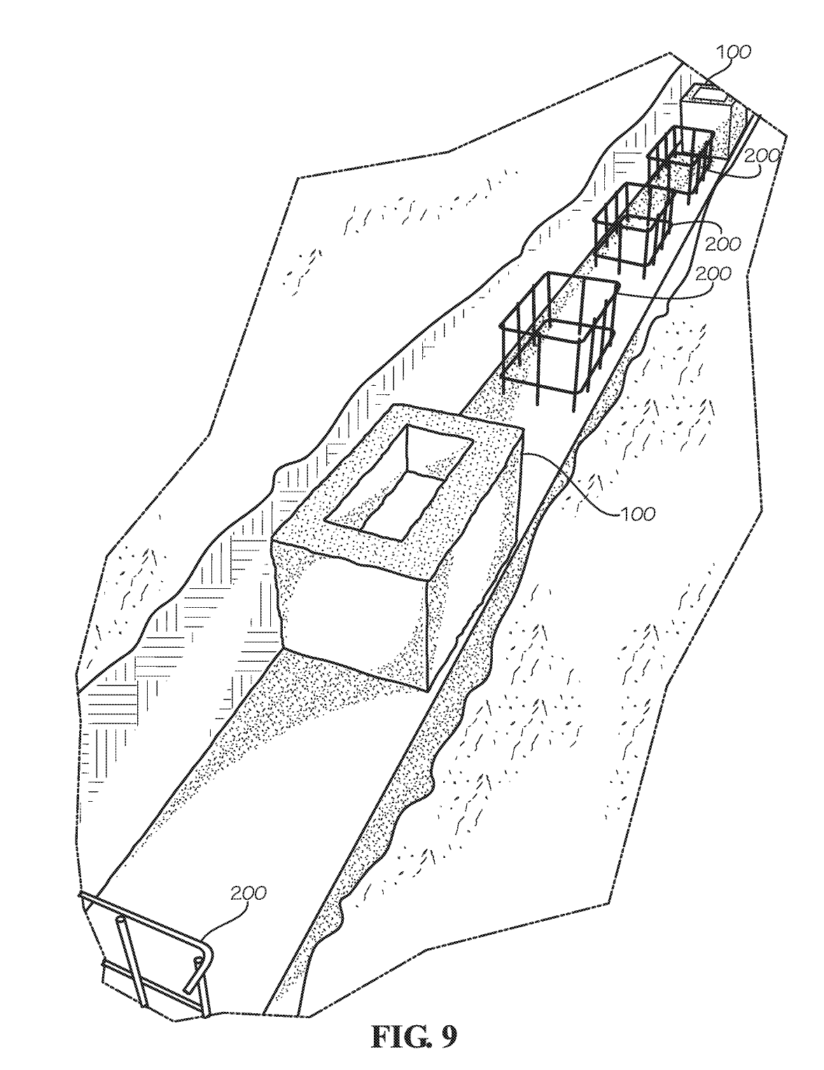

FIG. 1 is a top view of a fully-assembled poured-in-place concrete form 10, in accordance with an embodiment of the present disclosure. The poured-in-place concrete form 10 includes a base 12 and an insert 14 (In FIG. 1, the insert 14 is shown without its top cover 16, which is shown in FIGS. 3 and 8) that are configured to attach to each other for forming a headstone support box 100 (support box 100) around rebar framework (FIG. 9 illustrates the support box 100 and the rebar framework 200).

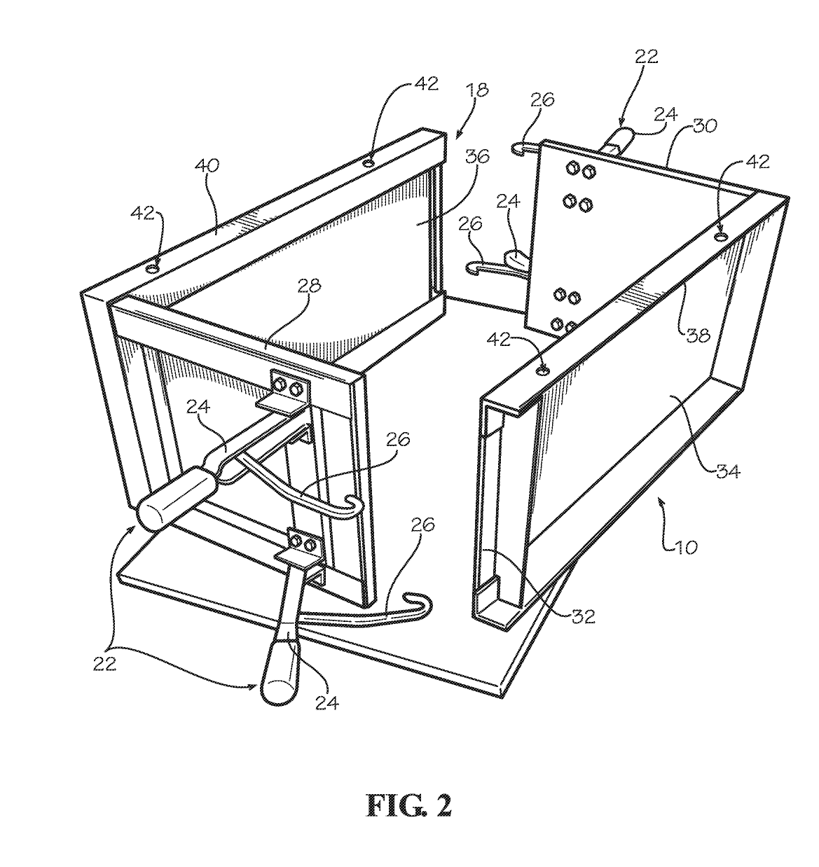

FIG. 2 is a perspective view of the base 12 which is shown including a pair of L-shape brackets 18 and 20 that create interlocking sides of the base 12 for positioning the base 12 around the rebar framework 200, as will be described in greater detail below. Each of the L-shape brackets 18 and 20 include one or more clamping members, or other suitable device, that can be used to couple the L-shape brackets 18 and 20 to each other to create the outside shape of the support box 100. In the illustrated embodiment, the clamping members can be in the form of a spring latch 22 including a handle 24 and a latch bar 26.

For illustrative purposes each of the L-shape brackets 18 and 20 is shown including two spring latches 22, which are located on short sidewall portions 28 and 30 of respective L-shape brackets 18 and 20 and coupled thereto using one or more suitable coupling devices, e.g., bolts, pins, rivets, screw, etc. Positioning the spring latches 22 along the short sidewall portions 28 and 30, as shown in the FIGs., allows for easy access and opening along narrow ends of a formed support box 100.

The latch bars 26 include a generally “hook” or “J” configuration and are configured to couple to a connection member 32, which is disposed on long sidewall portions 34 and 36 of the respective L-shape brackets 18 and 20, thereby allowing the L-shape brackets 18 and 20 to be coupled to one another; FIGS. 6-8 show the latch bars 26 coupled to the connection member 32.

Each of the long sidewall portions 34 and 36 includes a respective rail portion 38 and 40 that includes one or more apertures 42. For illustrative purposes, the rails 38 and 40 are each shown including two apertures 42; however, more or less apertures can be used.

FIG. 3 is a perspective view of the insert 14, shown with its cover 16 removed. The insert 14 includes a frame or casting member 44, which has a generally hollow, rectangular configuration; this hollow configuration provides an insert 14 that is relatively lightweight and easy to manipulate. The frame 44 is used to form the space within the support box 100, and the frame 44 can be gusseted for support and tapered for easy removal from a fully set support box 100. In the illustrated embodiment, the frame 44 includes a two inch taper from top to bottom; however, the frame 44 can be formed without a taper.

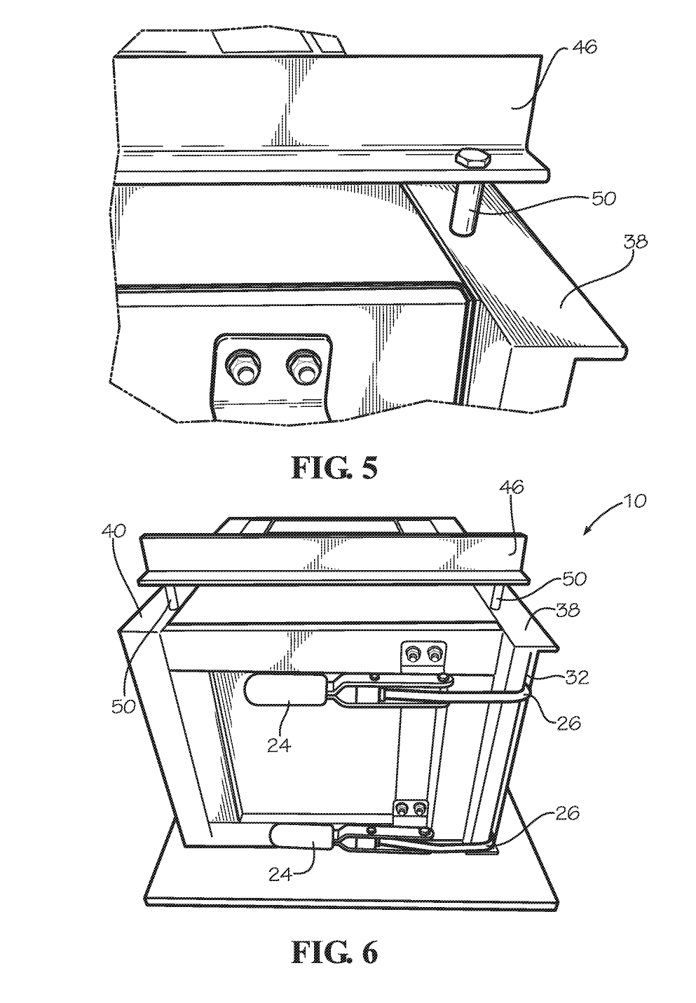

A pair of mounting assemblies 46 and 48 extend laterally across the frame 44. The mounting assemblies 46 and 48 are welded to the frame 44 and each includes a pair of mounting pins 50 that are receivable within a corresponding one of the apertures 42 which allows a user to couple the insert 14 to the base 12 and to set the dimensions and specifications of the space or slot of the support box 100 (FIGS. 4-7). The mounting pins 52 can be in the form of bolts (or other suitable device) that are welded to or screwed through the mounting assemblies 46 and 48; in the later instance, the bolts can be threaded and configured to screw into threaded apertures that can be provided on the mounting assemblies 46 and 48.

One or more spacers 52 can be provided within the frame 44 and can be used to maintain a specific spacing between the walls that define the frame 44. For illustrative purposes, a top spacer 52, which is centered within the frame 44 and which extends approximately two inches into the frame 44, is shown. As with the mounting assemblies 46 and 48, the spacer 52 can also be welded to the frame 44, or can be attached to the frame 44 via one or more other suitable attaching devices or methods. In embodiments, the frame 44 can be provided without the spacer 52.

The spacer 52 can also be used to support the cover 16 while the cover 16 is being welded to the frame 44. However, in embodiments, the cover 16 can be removably attached to the frame 44. In such an embodiment, a plurality of top spacers 52 can be provided within the frame 44 and used to temporality support the cover 16 on the frame 44.

Regardless of the method used for attaching or supporting the cover 16 to or on the frame 44, the cover 16 is used to prevent concrete, cement, or other suitable material from being introduced into the frame 44 as these materials are being poured into the assembled base 12 to form the support box 100.

The cover 16 includes one or more apertures 54 that are provided thereon to facilitate coupling and removing the insert 14 to and from the base 12.

The base 12 and insert 14 are formed from steel, but other suitable materials can also be used. In the illustrated embodiment, the base 12, in an assembled configuration, has a length of approximately 30 inches, a width of approximately 18 inches, and a height of approximately 15 inches, and the insert 14 is dimensioned so that when coupled to the base 12, the frame 44 is positioned at a center of an interior of the base 12 so as to form a space that is centered within the formed support box 100. As can be appreciated, the overall dimensions of the base 12, the insert 14, and the frame 44 can be varied to accommodate various size support boxes.

Operation of the poured-in-place concrete form 10 is now described. For illustrative purposes, the poured-in-place concrete form 10 is described herein as being used to form a support box 100 that is configured to be set within a National Cemetery, i.e., one used for burying military or other personal that served the United States.

In use, the L-shape brackets 18 and 20 can be positioned around rebar framework 200, which has been previously secured to or set into a pre-existing footing 300 (FIG. 2 illustrates the L-shape brackets 18 and 20 in the unassembled configuration (or uncoupled from one another) and FIG. 9 illustrates the rebar framework 200 set in the footing 300). It is noted, that the footing 300 is relatively large as it is used to receive a plurality of rebar framework 200 and support a plurality of support boxes 100. It is further noted, that a distance between each support box needs to be relatively exact so as to maintain a uniform appearance of the set headstones.

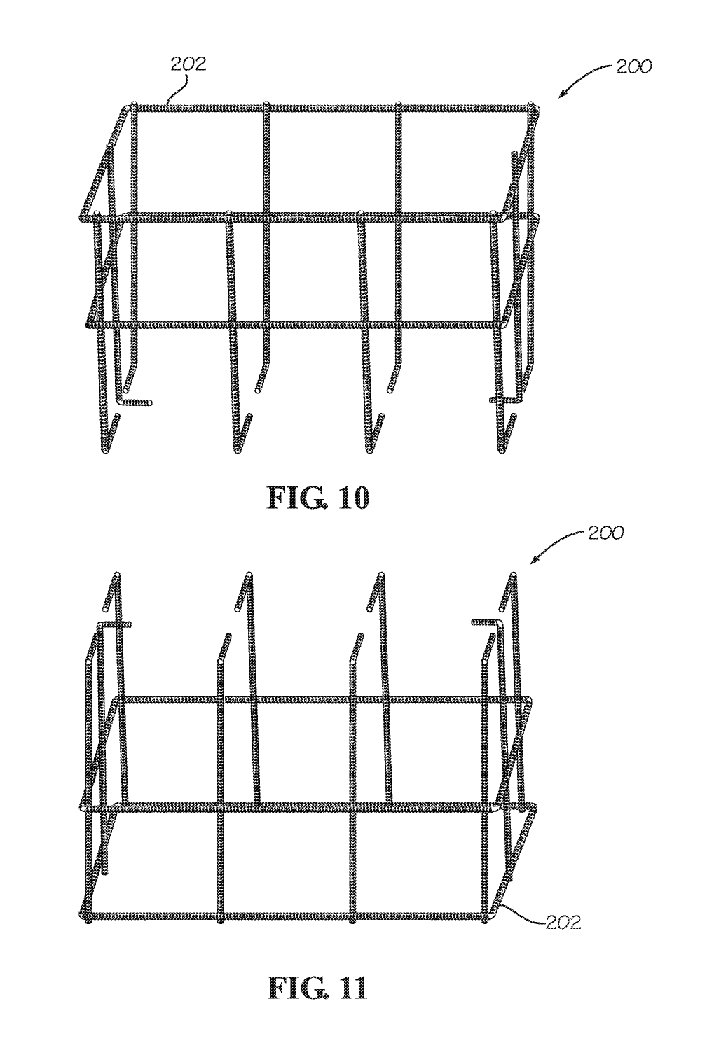

The rebar framework 200 includes a plurality of rebar components 202 that have been welded together to form one or more suitable configurations. For example, FIGS. 10 and 11 show one embodiment of the rebar framework 100. As illustrated in these FIGs. the rebar framework 200 includes ten rebar components 202 that when welded together form a generally box-like configuration similar to a configuration of the support box 100 after formation. To facilitate setting the rebar framework 100 into the footing 300, the bottom portions of the ten rebar components 202 can be bent to one or more suitable angles. In the illustrated embodiment, the bottom portions of the ten rebar components 202 have a ninety-degree bend. As can be appreciated, the rebar framework 200 can have more or less than ten rebar components 202.

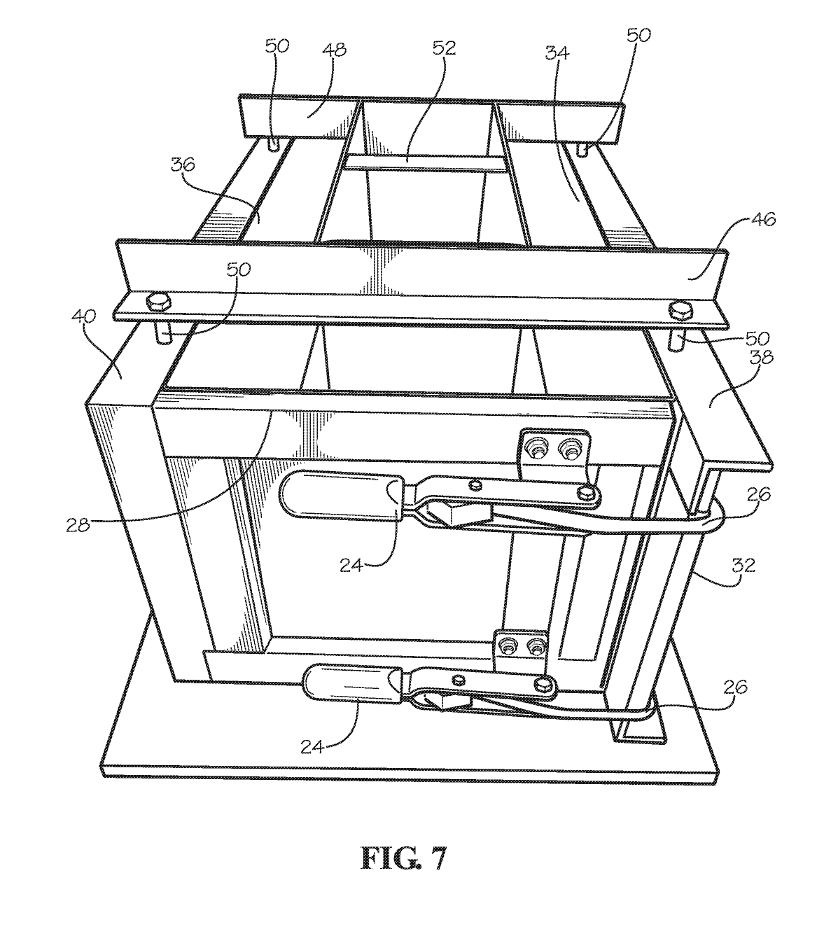

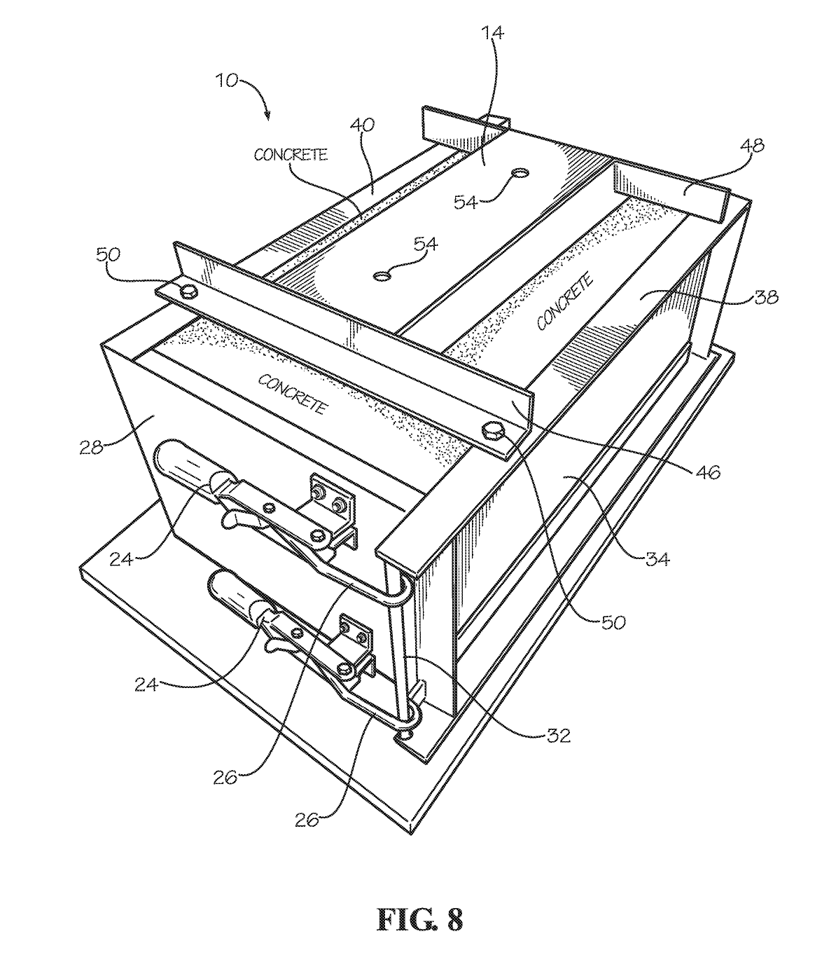

Once the L-shape brackets 18 and 20 have been positioned on the footing 300 around the rebar framework 200, the spring latches 22 of the L-shape brackets 18 and 20 can be used to couple the L-shape brackets 18 and 20 to one another (FIG. 6). With the L-shape brackets 18 and 20 coupled to one another, the mounting pins 50 of the mounting assemblies 46 and 48 can be positioned within a corresponding one of the apertures 42 of the rails 38 (FIG. 7).

Thereafter, the concrete, cement, or other suitable material can be poured into the assembled base 12 (FIG. 8) and allowed to harden therein, thereby forming the support box 100 with a space of suitable configuration (FIG. 9). That is, the space can then be used to receive and support a headstone (not shown).

The remaining support boxes 100 can be formed in a manner as described above.

If need be, sand (or other suitable material) can be added between the formed support box 100 and the headstone received therein to maintain the headstone in a relatively fixed orientation with respect to the support box 100.

The poured-in-place concrete form 10 allows a user to form a support box 100 in an easy, expeditious, and efficient manner. Moreover, unlike conventional concrete forms that are, typically, rendered unusable after being removed from a formed support box, the poured-in-place concrete form 10, which includes a base 12 including L-shape brackets 18 and 20 that are releasably coupleable to one another, described herein can be used multiple times.

From the foregoing and with reference to the various figure drawings, those skilled in the art will appreciate that certain modifications can also be made to the present disclosure without departing from the scope of the same. For example, in an assembled configuration the insert 14 can be movable with respect to the two L-shaped brackets 18 and 20, thereby allowing a user to adjust a location of the hole (or space) that is created in the support box 100 for receiving the headstone.

Moreover, while the poured-in-place concrete form 10 has been described herein as being used in conjunction with the rebar framework 200, the poured-in-place concrete form 10 can be used without the rebar framework 200.

Furthermore, while the frame 44 has been described herein as including a generally hollow configuration, the frame 44 can have other configurations. For example, the frame 44 can be made of a solid piece of steel (or other metal). In this instance, the cover 16 can be omitted, as the likelihood of concrete or cement being introduced into the frame 44 is eliminated.

Additionally, while the frame 44 has been described herein as having a generally rectangular configuration, other configurations can be used. For example, the frame 44 can have any geometric shape including, but not limited to, a square, circle, triangle, etc.

Also, while the insert 14 has been described herein as including one frame 44, more than one frame 44 can be provided on the insert 14. For example, two, three, four, . . . , frames 44 can be provided on the insert 14 and evenly spaced apart from one another to form a support box 100 with multiple spaces.

While several embodiments of the disclosure have been shown in the drawings, it is not intended that the disclosure be limited thereto, as it is intended that the disclosure be as broad in scope as the art will allow and that the specification be read likewise. Therefore, the above description should not be construed as limiting, but merely as exemplifications of particular embodiments. Those skilled in the art will envision other modifications within the scope and spirit of the claims appended hereto.

What is claimed is:

1. An apparatus for forming a support box, the apparatus comprising:
a base; and
an insert attachable to the base,
wherein, with the insert attached to the base, at least one suitable material is receivable within the base and allowed to harden, thereby forming a support box with at least one space for receiving a headstone.

2. The apparatus according to claim 1, wherein the base includes a pair of L-shape brackets.

3. The apparatus according to claim 1, wherein each of the L-shape brackets includes at least one clamping member.

4. The apparatus according to claim 1, wherein each of the L-shape brackets includes a rail having at least one aperture.

5. The apparatus according to claim 4, wherein the insert includes a cover and at least one mounting assembly including at least one mounting pin that is receivable within at least one aperture of the rail of at least one of the L-shape brackets.

6. The apparatus according to claim 1, wherein the apparatus further comprises rebar framework, which is configured to be set into a footing.

7. The apparatus according to claim 1, wherein the at least one suitable material is one of concrete or cement.

8. A method for forming a support box, the method comprising:
positioning a base around rebar framework;
positioning an insert within the base;
pouring at least one suitable material within the base; and
allowing the at least one suitable material to harden, thereby forming a support box with at least one space for receiving a headstone.

9. The method according to claim 8, wherein positioning the base around the rebar framework comprises coupling a pair of L-shape brackets of the base to each other using at least one clamping member that is attached to each of the L-shape brackets.

10. The method according to claim 9, wherein positioning the insert within the base comprises engaging at least one mounting pin of a mounting assembly of the insert with at least one aperture of a rail of at least one of the L-shape brackets for attaching the insert to the base.

11. The method according to claim 10, further comprising, subsequent to allowing the at least one suitable material to harden, un-attaching the insert from the base and uncoupling the L-shape brackets from one another.

12. The method according to claim 9, wherein pouring at least one suitable material within the base comprises pouring at least one of concrete or cement within the base.

13. The method according to claim 9, further comprising, prior to positioning the base around the rebar framework, setting the rebar framework into a footing.

14. A system for forming a support box, the system comprising:
rebar framework configured to be set into a footing;
a base including a pair of L-shape brackets configured to releasably couple to one another; and
an insert attachable to the base when the pair of L-shape brackets are coupled to one another,
wherein, with the insert attached to the base, at least one suitable material is receivable within the base and allowed to harden, thereby forming a support box with at least one space for receiving a headstone.

15. The system according to claim 14, wherein each of the L-shape brackets includes at least one clamping member.

16. The system according to claim 14, wherein each of the L-shape brackets includes a rail having at least one aperture.

17. The system according to claim 16, wherein the insert includes a cover and at least one mounting assembly including at least one mounting pin that is receivable within at least one aperture of the rail of at least one of the L-shape brackets.

18. The system according to claim 14, wherein the at least one suitable material is one of concrete or cement.
